(19) United States
(12) Patent Application Publication
(10) Pub. No.: US 2026/0297238 A1
(43) Pub. Date: Oct. 1, 2026

(54) PROCESS FOR PREPARING BLOCK COPOLYMER

(71) Applicant: BYK-Chemie GmbH, Wesel (DE)

(72) Inventors: Sebastian Weiss, Dusseldorf (DE); Marcel Schumacher, Munster (DE); Michael Kaupp, Dusseldorf (DE); Ina Van Kamp, Dinslaken (DE); Astrid Rudolfi, Voerde (DE); Jennifer Heitzer, Wesel (DE); Givara Ebish, Hamminkeln (DE)

(21) Appl. No.: 19/479,746

(22) PCT Filed: May 6, 2024
(86) PCT No.: PCT/EP2024/062440

§ 371 Date: Oct. 29, 2025

(30) Foreign Application Priority Data
May 11, 2023 (EP) 23172735.5

(51) Int. Cl. C08F 293/00; C09D 7/45; C09D 7/65; C09D 17/00; C09D 133/04

(52) U.S. Cl. CPC C08F 293/005; C09D 7/45; C09D 7/65; C09D 17/001; C09D 133/04; C08F 2438/03

(57) ABSTRACT

The invention relates to process for preparing a block copolymer comprising polymerizing in an aqueous medium under reversible-addition-fragmentation chain-transfer polymerization conditions a) a first monomer composition comprising methacrylic acid in an amount of 0.0 to 40.0 mol-%, and at least 50.0 mol-% of one or more ethylenically unsaturated polymerizable monomers having a water solubility of more than 500 g/l at 20° C., selected from monomers having ether groups and monomers having hydroxyl groups, to prepare a first polymer block, and b) a second monomer composition comprising at least 60.0% by weight of one or more ethylenically unsaturated polymerizable monomers having a water solubility of less than 50 g/l at 20° C. to prepare a second polymer block.

The invention relates to a process for preparing a block copolymer, to a block copolymer comprising a first block and a second block, to the use of the block copolymer as a dispersing agent for solid particles, to a process of dispersing solid particles, and to a coating composition.

U.S. Pat. No. 8,658,741 B describes the preparation of block copolymers. The process involves preparation of a homopolymer of butyl acrylate in an organic solvent in a first step. In the second step, a second polymer block is prepared from 4-vinylpyridine. In a third step, the butylester groups are partly transesterified with polyethylene glycol monomethylether. A drawback of this process is that is comprises an additional step of transesterification, which requires additional time and energy. The resulting butanol has to be distilled off. Furthermore, the polymerization process is carried out in an organic solvent. If an aqueous polymer solution is desired, the organic solvent has to be removed by distillation.

U.S. Pat. No. 10,280,101 B relates to water soluble chain transfer agents. The document describes water soluble RAFT agents, which can be used to controllably polymerize water soluble monomers directly in water. Water soluble block copolymers are envisaged. Polyethylene glycol monoacrylate and polyethylene glycol monomethacrylate are mentioned as suitable water-soluble monomers.

Zhang et al., Macromolecules 2011, 44, 7584-7593, relates to a one-pot synthesis of poly(methacrylic acid-co-poly(ethylene oxide) methyl ether methacrylate)-block-polystyrene amphiphilic block copolymers via RAFT-mediated radical emulsion polymerization.

There is a need for a for a simple process of preparing block copolymers in an aqueous medium to avoid solvent removal, which provides block copolymers, which are suitable as dispersing agents for solid particles, in particular pigment and filler particles.

The invention provides a process for preparing a block copolymer comprising polymerizing in an aqueous medium under reversible-addition-fragmentation chain-transfer polymerization conditions
a) a first monomer composition comprising methacrylic acid in an amount of 0.0 to 40.0 mol-%, and at least 50.0 mol-% of one or more ethylenically unsaturated polymerizable monomers having a water solubility of more than 500 g/l at 20° C., selected from monomers having ether groups and monomers having hydroxyl groups to prepare a first polymer block, and
b) a second monomer composition comprising at least 60.0% by weight of one or more ethylenically unsaturated polymerizable monomers having a water solubility of less than 50 g/l at 20° C. to prepare a second polymer block.

The process of the invention leads to block copolymers which are highly suitable as dispersants for solid particles, in particular for filler and pigment particles. The process neither requires a transesterification step nor the distillation of solvent to provide an aqueous block copolymer solution or emulsion. In addition, the process can be carried out at moderate temperature. Hence, the process is simple, requires less energy, creates no waste and is therefore environmentally sustainable.

The process of the invention leads to block copolymers. Block copolymers comprise at least two different polymer blocks or segments linked to each other. The first polymer block and the at least one second polymer block have different monomer compositions. The individual polymer blocks may comprise one or more than one type of repeating unit. Hence, the individual polymer blocks may be prepared from one type of monomer, or from two or more types of monomers. In some embodiments, the block copolymers consist of the first block and the second block. In further embodiments, the first block and the second block are linked to each other by an intermediate polymer section, wherein the monomer composition gradually changes from the composition of the first polymer block to the second polymer block. In a still further embodiment, the block copolymer comprises a third polymer block, which may be located between the first and second block. Alternatively, a third polymer block may be a terminal block located adjacent to the first or second polymer block.

The process of the invention is carried out in an aqueous medium. The aqueous medium generally is a continuous aqueous phase. The continuous aqueous phase generally has a water content in the range of 40.0 to 100.0% by weight, preferably 50.0 to 100.0% by weight, and more preferably 60.0 to 100.0% by weight. If so desired, water-miscible organic solvents can be included in the aqueous phase, suitably in amount of 0.0 to 30.0% by weight, preferably 0.0 to 20.0% by weight, and more preferably in an amount of 0.0 to 10.0% by weight, calculated on the amount of water present in the aqueous phase.

In the process of the invention, monomers are polymerized under reversible addition-fragmentation chain-transfer polymerization conditions. Reversible addition-fragmentation chain-transfer or RAFT polymerization is one of several kinds of reversible-deactivation radical polymerization. It makes use of a chain-transfer agent in the form of a thiocarbonyl-thio compound or similar to afford control over the generated molecular weight and polydispersity during a radical polymerization. RAFT polymerization is one of several living or controlled radical polymerization techniques, others being for example atom transfer radical polymerization (ATRP) and nitroxide-mediated polymerization (NMP). RAFT polymerization uses thiocarbonyl-thio compounds, such as trithiocarbonates, dithioesters, thiocarbamates, and xanthates, to mediate the polymerization via a reversible chain-transfer process.

In step a) of the process of the invention a first monomer composition is polymerized to prepare a first polymer block. The first monomer composition comprises one or more ethylenically unsaturated polymerizable monomers.

Suitable ethylenically unsaturated monomers that form the first block in the block copolymer are generally selected from acrylic esters, methacrylic esters, acrylamides and/or methacrylamides. Herein the term “(meth)acryl” refers to both methacryl and acryl. The same applies for the term “(meth)acrylate” which refers to both methacrylate and acrylate, likewise.

Preferred are esters of methacrylic acid, rather than esters of acrylic acid.

It has been found that the presence of large amount of carboxylic acid-functional monomers detracts from the properties of the block copolymer, in particular when the block copolymer is used as a dispersant for solid particles. Therefore, the amount of methacrylic acid in the first monomer composition does not exceed 40.0 mol-%, calculated on the total amount of ethylenically unsaturated monomers in the first monomer composition.

Thus, the first monomer composition comprises methacrylic acid in an amount of 0.0 to 40.0 mol-%. In preferred embodiments, the first monomer composition comprises methacrylic acid in an amount of 0.0 to 25.0 mol-%, even more preferred in an amount of 0.0 to 15.0 mol-%, and most preferably in an amount of 0.0 to 7.0 mol-%.

The first monomer composition comprises at least 50 mol-% of one or more ethylenically unsaturated polymerizable monomers having a water solubility of more than 500 g/l at 20° C., selected from monomers having ether groups and monomers having hydroxyl groups. In preferred embodiments, the first monomer composition comprises 70 to 100 mol-%, more preferably 80 to 100 mol-%, or even 90 to 100 mol-% of one or more ethylenically unsaturated polymerizable monomers having a water solubility of more than 500 g/l at 20° C.

In all cases, the mol-% are calculated on the total amount of ethylenically unsaturated monomers in the first monomer composition.

In further preferred embodiments, first monomer composition comprises at least 60% by weight of one or more ethylenically unsaturated polymerizable monomers having a water solubility of more than 500 g/l at 20° C., calculated on the total weight of monomers of the first monomer composition. Generally, the first monomer composition comprises 60 to 100%, preferably 80 to 100% by weight of one or more ethylenically unsaturated polymerizable monomers having a water solubility of more than 500 g/l at 20° C.

The ethylenically unsaturated polymerizable monomers of the first monomer composition generally have one ethylenically unsaturated polymerizable group. If so desired, small amounts of monomers having two or more ethylenically unsaturated polymerizable groups may be present in the first monomer composition. Such monomers may be present in an amount of 0.0 to 3.0 mol-%, calculated on the total amount of ethylenically unsaturated monomers in the first monomer composition.

Suitable monomers having a water solubility of more than 500 g/l at 20° C. are monomers having ether groups and monomers having hydroxyl groups. Very suitable are monomers having a plurality of non-cyclic ether groups, such as ether groups obtained by ring-opening polymerization of alkylene oxides, in particular ethylene oxide and propylene oxide.

Examples of very suitable monomers are mono-methacrylates of polyethyleneglycol or of mono-ethers of polyethyleneglycol. Suitable mono-ethers include methylethers, ethylethers, propylethers, and butylethers. The polyethyleneglycol suitably has from 2 to 100 polymerized units of ethylene oxide, preferably from 3 to 50 units ethylene oxide, more preferably from 3 to 20 units of ethylene oxide. In some embodiments, the number of polymerized units of ethylene oxide is in the range of 4 to 15.

Other suitable monomers having a water solubility of more than 500 g/l at 20° C. are hydroxyl-functional monomers, such as 2-hydroxyethyl acrylate and 2-hydroxyethyl methacrylate.

The second monomer composition comprises at least 60% by weight of one or more ethylenically unsaturated polymerizable monomers having a water solubility of less than 50 g/l at 20° C. The weight-% is calculated on the total weight of ethylenically unsaturated polymerizable monomers in the second monomer composition. In preferred embodiments, the second monomer composition comprises 70 to 100% by weight, more preferably 80 to 100% by weight, or even 90 to 100% by weight of one or more ethylenically unsaturated polymerizable monomers having a water solubility of less than 50 g/l at 20° C.

Examples of suitable monomers having a water solubility of less than 50 g/l at 20° C. are (meth)acrylic esters of straight-chain, branched or cycloaliphatic alcohols having 1 to 22, preferably 1 to 12, more preferably 1 to 8 and most preferably 1 to 6 carbon atoms, such as methyl (meth)acrylate, ethyl (meth)acrylate, n-butyl (meth)acrylate, tert-butyl (meth)acrylate, n-hexyl (meth)acrylate, isobutyl (meth)acrylate, isopentyl (meth)acrylate, lauryl (meth)acrylate, 2-ethylhexyl (meth)acrylate, stearyl (meth)acrylate, cyclohexyl (meth)acrylate, behenyl (meth)acrylate, isodecyl (meth)acrylate, 2-propylheptyl (meth)acrylate, 3,5,5-trimethyl-1-hexyl (meth)acrylate, nonanyl (meth)acrylate, 2-propylheptyl (meth)acrylate, 2-isopropyl-5-methyl-hexyl (meth)acrylate, tridecyl (meth)acrylate, heptadecyl (meth)acrylate, heneicosanyl (meth)acrylate and isobornyl (meth)acrylate; and aryl (meth)acrylic esters whose aryl ring, without possible additional substituents, contains 5 to 12, preferably 6 to 10, carbon atoms, such as phenyl acrylate; and aralkyl (meth)acrylic esters whose aralkyl radical, without possible additional substituents on the aryl radical, contains 6 to 11, preferably 7 to 11, carbon atoms, such as benzyl methacrylate, it being possible for the aryl radicals of the aryl (meth)acrylic esters and of the aralkyl (meth)acrylic esters in each case to be unsubstituted or to be substituted up to four times, such as, for example, 4-methylphenyl methacrylate. In preferred embodiments, the second monomer composition comprises or consists of polymerizable vinyl aromatic compounds.

In a particularly preferred embodiment, the second monomer composition comprises at least one of 4-vinylpyridine, 2-vinylpyridine, and styrene.

The ethylenically unsaturated polymerizable monomers of the second monomer composition generally have one ethylenically unsaturated polymerizable group. If so desired small amounts of monomers having two or more ethylenically unsaturated polymerizable groups may be present in the second monomer composition. Such monomers may be present in an amount of 0.0 to 3.0 mol-%, calculated on the total amount of ethylenically unsaturated monomers in the second monomer composition.

The weight ratio of ethylenically unsaturated polymerizable monomers of first monomer composition to the ethylenically unsaturated polymerizable monomers of the second monomer composition generally is in the range of 50:50 to 95:5, preferably in the range of 70:30 to 95:5, and even more preferably in the range of 75:25 to 95:5.

In preferred embodiments, the block copolymer prepared according to the process of the invention has a number average molecular weight Mₙ in the range of 5000 to 30000 g/mol, more preferably in the range of 8000 to 20000 g/mol.

It is further preferred that the block copolymer has a polydispersity in the range of 1.1 to 2.0, preferably 1.1 to 1.8. The polydispersity is the quotient of weight average molecular weight M_{w}/number average molecular weight Mₙ.

The number average molecular weight Mₙ and weight average molecular weight M_{w} are suitably determined by gel permeation chromatography, using polystyrene as calibration standard and tetrahydrofuran as eluent.

As mentioned above, the process of the invention comprises polymerizing in an aqueous medium under reversible-addition-fragmentation chain-transfer polymerization conditions. Such processes are generally known as RAFT polymerization involving a degenerate-transfer radical polymerization in which chain activation and chain deactivation involve a degenerative chain-transfer process which occurs by a two-step addition-fragmentation mechanism.

To accomplish the reversible-addition-fragmentation chain transfer polymerization, the process is suitably carried out in the presence of
i) a radical generating agent having a water solubility of more than 10 g/l at a temperature of 20° C., and
ii) a chain transfer agent having a thiocarbonyl-thio group of the formula (I) —C(═S)—S—.

Examples of suitable radical generic agents are compounds having a peroxide group or an azo group, which readily decompose under the formation of free radicals. Persulfates, such as potassium persulfate and ammonium persulfate, are suitable as well. To achieve the required water solubility, the radical generating agent may further comprise one or more carboxylic acid groups or salts thereof. Examples of suitable radical generating agents include 4,4′-azobis(4-cyanovaleric acid) or salts thereof, (2,2′-azobis[N-(2-carboxyethyl)-2-methylpropionamidine]tetrahydrate), (2,2′-azobis(2-methylpropionamidine)dihydrochloride) 2,2′-azobis(isobutyronitrile) (AIBN), 2,2′-azobis(2-cyano-2-butane), dimethyl 2,2′-azobisdimethylisobutyrate, 4,4′-azobis(4-cyanopentanoic acid), 1,1′-azo-is(cyclohexanecarbanitrile), 2-(t-butylazo)-2-cyanopropane, 2,2′-azobis[2-methyl-N-(I,I)-bis(hydroxymethyl)-2-hydroxyethyl]propionamide, 2,2′-azobis[2-methyl-N-hydroxyethyl)]-propionamide, 2,2′-azobis(N,N′-dimethyleneisobutyramidine)dihydrochloride, 2,2′-azobis(2-amidinopropane)dihydrochloride, 2,2′-azobis(N,N′-di-methyleneisobutyramine), 2,2′-azobis(2-methyl-N-[I,I-bis(hydroxymethyl)-2-hydroxyethyl]propionamide), 2,2′-azobis(2-methyl N-[1,1-bis(hydroxymethyl)ethyl]propionamide), 2,2′-azobis[2-methyl-N-(2-hydroxyethyl)propionamide], 2,2′-azobis(isobutyramide) dehydrate, 2,2′-azobis(2,2,4-trimethylpentane), 2,2′-azo-bis(2-methylpropane), t-butyl peroxyacetate, t-butylperoxy-2-ethylhexanoate, t-butyl peroxybenzoate, t-butyl peroxyoctoate, t-butylperoxyneodecanoate, t-butylperoxy sobutyrate, t-amyl peroxypivalate, t-butyl peroxypivalate, di-isopropyl peroxydicar-onate, dicyclohexyl peroxydicarbonate, dicumyl peroxide, dibenzoyl peroxide, di-auroylperoxide, potassium peroxydisulfate, ammonium peroxydisulfate, di-t-butyl hyponitrite, and dicumyl hyponitrite

The achieve a reversible-addition-fragmentation chain transfer polymerization, the process is preferably carried out in the presence of chain transfer agent having a thiocarbonyl-thio group of the formula (I) —C(═S)—S—.

Examples of suitable chain transfer agents include dithioesters, thiocarbamates, trithiocarbonates, and xanthates, to mediate the polymerization via a reversible chain-transfer process. Specific examples of suitable chain transfer agents include 4-cyano-4-(((dodecylthio) carbonothioyl)thio) valeric acid, 3-((((1-carboxyethyl)thio) carbonothioyl)-thio)propanoic acid 2 (((dodecylthio) carbonothioyl)thio)propanoic acid, 2-(butylthiocarbono-thioylthio)propanoic acid, 4-cyano-4-(phenylcarbonothioylthio)pentanoic acid, 4-cyano-4-(phenylcarbonothioylthio)pentanoic acid, 2-(dodecylthiocarbonothioylthio)-2-methylpropionic acid, 4-cyano-4-(phenylcarbonothioylthio)pentanoic acid, and 4-((((2-carboxyethyl)thio)-carbonothioyl)thio)-4-cyanopentanoic acid.

During the process of the invention, foam may be formed due to stirring or agitation of the aqueous medium and the presence of organic components. It is therefore preferred that the process of the invention is carried out in the presence of a defoaming agent. A defoaming agent prevents or reduces the formation of foam or facilitates the decomposition of foam. Suitable defoaming agents are silicone-based defoaming agents as well as silicone-free defoaming agents. Examples of silicone-free defoaming agents are hydrocarbon-based defoaming agents, such as mixtures of C₄ to C₃₀ aliphatic or aromatic hydrocarbons. It is also possible to use mixtures and combinations of different types of defoaming agents. Defoaming agents are generally used in low amounts, which are sufficient to effectively prevent or sufficiently reduce the formation of foam. The amount of defoaming agent or combination of defoaming agents is generally in the range of 0.1 to 2.5% by weight, calculated on the weight of the monomers employed in the process.

The reversible-addition-fragmentation chain-transfer polymerization is suitably carried out at temperatures in the range of 35 to 100° C., preferably 50 to 95° C., and at atmospheric pressure for a duration sufficient to achieve substantially complete polymerization of the ethylenically unsaturated polymerizable monomers. Generally, the duration of the polymerization is from 30 minutes to 300 minutes for each polymer block to be prepared. The polymerization is carried out in a suitable reactor with temperature control means, dosing means, and a stirrer. The first monomer composition is polymerized in a first polymerization step. The first monomer composition may be added to the reactor in one or more dosing steps, or it may be dosed into the reactor continuously during polymerization. The initiator and chain transfer agent may be introduced into the reactor simultaneously or separately from the monomer composition. When the polymerization of the first monomer mixture is completed, the second monomer composition is polymerized analogously.

In some embodiments, the process of the invention consists of the steps of polymerizing a first monomer composition and a second monomer composition, as described above. This leads to block copolymers consisting of a first block and a second block. In some embodiments, the second block is polymerized directly after preparation of the first block, for example in the same reactor. If so desired, the second block can also be prepared at a later stage, for example after storage of the first block, in the same reactor or in a different reactor.

In other embodiments, the process comprises a third step, wherein a third monomer composition is added after preparation of the second block to prepare a third block. The third monomer composition generally comprises one or more ethylenically unsaturated polymerizable monomers. When the second monomer composition comprises at least one of 4-vinylpyridine and 2-vinylpyridine, the third monomer preferably comprises at least one of styrene, 2-methylstyrene, 3-methylstyrene, 4-methylstyrene, alpha-methylstyrene, and beta-methylstyrene. Examples of other suitable monomers for the third block are benzyl methacrylate, methyl methacrylate, ethyl methacrylate, methyl acrylate, ethyl acrylate, butyl acrylate, and hydroxypropyl methacrylate. The amount of monomers in the third monomer composition generally is in the range of 2 to 30% by weight, calculated on the amount of monomers in the second monomer composition. It has been found that the use of a third monomer composition can significantly reduce the amount of residual free monomers in the block copolymer.

The process of the invention leads to composition comprising the block copolymer in an aqueous medium, wherein the block copolymer is dissolved or dispersed. In many cases, the aqueous composition can be used for further purposes, as described below. If so desired, the amount of water can be adjusted for a particular purpose. In some cases, the amount of water may be reduced by distillation to adjust the water content to a suitable level for particular applications. If so desired, the majority of water can be removed by distillation to obtain a block copolymer which has a water content in the range of 0 to 10% by weight, calculated on the weight of block copolymer.

The invention further relates to the block copolymer obtainable by the process of the invention. This is a block copolymer comprising
a) a first block comprising polymerized units of one or more ethylenically unsaturated polymerizable monomers, wherein the first block comprises polymerized units of methacrylic acid in an amount of 0.0 to 40.0 mol-%, and at least 50.0 mol-% of polymerized units of one or more ethylenically unsaturated polymerizable monomers having a water solubility of more than 500 g/l at 20° C., selected from monomers having ether groups and monomers having hydroxyl groups, and
b) a second block comprising polymerized units of one or more ethylenically unsaturated polymerizable monomers, wherein the second block comprises at least 60.0% by weight of polymerized units of one or more ethylenically unsaturated polymerizable monomers having a water solubility of less than 50 g/l at 20° C.

In typical embodiments of the polymer, the weight ratio of the first block to the second block is in the range of 50:50 to 95:5, preferably in the range of 70:30 to 95:5, and even more preferably in the range of 75:25 to 95:5.

Otherwise, the embodiments described above for the process of the invention with respect to the monomer types and monomer compositions apply analogously for the polymer of the invention.

As mentioned above, the process of the invention leads to a block copolymer in an aqueous medium. Therefore, the invention also relates to an aqueous composition comprising water and the block copolymer of the invention.

The invention also concerns using the block copolymer as described above or produced as described above as an additive, preferably as a wetting and dispersing agent for solid particles, preferably in coatings, paints, plastics, pigment pastes, sealants, ceramics, cosmetics, adhesives, casting compounds, fillers, battery applications, gas and oilfield applications, spackling compounds, inks and printing colors. The block copolymer can be used as a dispersant additive for electrically conductive carbon-based material. Examples of suitable electrically conductive carbon-based materials include carbon black, carbon nano tubes, graphite, carbon fibers, graphene, fullerenes, and mixtures thereof. Preferred carbon-based materials are carbon black, graphene, and carbon nano tubes. Such dispersed electrically conductive carbon-based materials can suitably be included in electrode slurries or electrode pastes for rechargeable batteries. The expression battery encompasses a single electrochemical cell that contains electrodes, a separator, and an electrolyte, as well as a collection of cells or cell assemblies.

The invention also relates to the use of the block copolymer or the aqueous composition according to the invention as a wetting or dispersing agent for solid particles.

The invention further relates to a process of dispersing solid particles in a dispersion medium, comprising the steps
i) Providing the block copolymer or the aqueous composition of the invention,
ii) Providing solid particles,
iii) Providing an aqueous dispersion medium or using the water of the aqueous composition as dispersion medium,
iv) Mixing the components provided in steps i) to iii) in any suitable order and exerting shear force.

The block copolymers according to the invention are used, for example, as aluminum passivators, dispersants, dispersion stabilizers, surfactants or wetting agents and can be used, for example, in pigmented and/or filler-containing products, for example, pigment concentrates or pastes, coating compositions, sealants, plastics, ceramics, cosmetics, adhesives, casting compounds, spackling compounds, inks and/or printing inks. Preferred pigment concentrates are those which can be mixed with appropriate paint systems, thereby producing pigmented paints.

The block copolymers may thus be used, for example, in the production or processing of paints, coatings, inks and printing colors, for example, for inkjet printing, paper coatings, leather and textile inks, pastes, pigment concentrates, ceramics, adhesives and sealants, casting compounds, plastics and cosmetic preparations, in particular when these contain solids, such as pigments and/or fillers or fibrous materials.

The block copolymers may also be used to produce, for example, casting compounds, potting materials, PVC plastisols, gel coats, polymer concrete, circuit boards, industrial paints, wood and furniture paints, automotive paints and enamels, (antifouling) marine paints, anticorrosion paints, can and coil coatings or painter and architectural paints.

Typically, the product containing the block copolymer, as well as pigments and/or fillers, is a paint, or a pigment concentrate for coating compositions.

Therefore, the invention further relates to a coating composition comprising
a) Solid particles,
b) The block copolymer according of the invention, and
c) A film-forming binder.

In preferred embodiments, the coating composition is an aqueous composition comprising a continuous aqueous phase.

The pigments used may be the pigments known to those skilled in the art. Examples of suitable pigments include mono-, di-, tri- and polyazo pigments, oxazine, dioxazine, thiazine pigments, diketo pyrrolopyrroles, phthalocyanines, ultramarine and other metal complex pigments, indigoid pigments, diphenylmethane pigments, triarylmethane pigments, xanthene pigments, acridine pigments, quinacridone pigments, methine pigments, anthraquinone, pyranthrone, perylene pigments and other polycyclic carbonyl pigments, carbon black pigments and/or pigments based on carbon black, such as graphite.

The pigments used may be inorganic pigments, such as zinc, titanium dioxide, zinc oxide, zinc sulfide, zinc phosphate, barium sulfate, lithophones, iron oxide, ultramarine, manganese phosphate, cobalt aluminate, cobalt stannate, cobalt zincate, antimony oxide, antimony sulfide, chromium oxide, zinc chromate, mixed metal oxides based on nickel, bismuth, vanadium, molybdenum, cadmium, titanium, zinc, manganese, cobalt, iron, chromium, antimony, magnesium, aluminum (for example, nickel titanium yellow, bismuth vanadate molybdate yellow or chromium titanium yellow).

Inorganic pigments can be magnetic pigments based on pure iron, iron oxides and chromium oxides or mixed oxides, metallic effect pigments of aluminum, zinc, copper or brass as well as pearlescent pigments or fluorescent and phosphorescent pigments. Other examples include nanoscale organic or inorganic solids with particle sizes of less than 100 nm in at least one dimension, such as certain types of carbon black or other allotropic forms of carbon, such as single-wall CNTs, multi-wall CNTs and graphene. The particle size is determined, for example, by means of transmission electron microscopy, analytical ultracentrifugation, or light scattering methods.

Particles consisting of a metal oxide and/or hydroxide or a semimetal oxide and/or hydroxide as well as particles consisting of mixed metal oxides and/or hydroxides and/or semimetal oxides and/or hydroxides may also be mentioned. For example, the oxides and/or oxide hydroxides of aluminum, silicon, zinc, titanium, etc. may be used for the production of such extremely finely divided solids.

Where the respective products, especially the coating compositions, contain fillers, the fillers are, for example, fillers known to the person skilled in the art. Examples of powdery or fibrous fillers are, for example, those which are composed of powdery or fibrous particles of alumina, aluminum hydroxide, silica, diatomaceous earth, siliceous earth, quartz, silica gel, talc, kaolin, mica, perlite, feldspar, slate flour, calcium sulfate, barium sulfate, calcium carbonate, calcite, dolomite, glass or carbon. The fibers used may be organic and/or inorganic in nature and are also used as reinforcement materials.

Flame retardants, such as aluminum or magnesium hydroxide, and matting agents, such as silicas, can also be dispersed and stabilized particularly well by the block copolymers according to the invention.

The block copolymers according to the invention can also be used for surface treatment of fibers or particles, such as pigments or fillers to improve their processing properties or compatibility.

Depending on the field of application, the block copolymers according to the invention are used in amounts such that the product ultimately interesting for further application contains a proportion of the block copolymer of the invention advantageously from 0.01 to 10.00% by weight, based on the total amount of the respective product. However, even larger amounts are also possible. Based on the solid particles to be dispersed, for example, the pigment, the block copolymer according to the invention is used in an amount of preferably 0.50 to 100.00% by weight.

When using solids that are difficult to stabilize, the amount of block copolymer according to the invention may be much higher. The concentration of block copolymer needed depends in general on the specific surface area of the solid to be dispersed. Generally, it can be stated that the stabilization of inorganic pigments generally requires less dispersant than is required for stabilizing organic pigments, as the latter tend to have a higher specific surface and therefore require a larger amount of dispersant. Typical doses of the block copolymer for inorganic pigments are 1 to 30% by weight, for organic pigments 10 to 50% by weight, each based on the solid to be dispersed, in particular the pigment. In case of very finely divided pigments, for example, some carbon blacks, added amounts of 30 to 90% or more are needed. The criteria for sufficient pigment stabilization can include, for example, gloss and transparency of the coating compositions, or the degree of floating.

The dispersion of the solids can take place as grinding a single solid or as grinding a mixture of multiple pigments simultaneously, with the best results usually being achieved with grinding a single solid.

The products, in particular the coating compositions and/or paints, wherein the block copolymer according to the invention should ultimately manifest their effects, may also contain an organic polymer as a binder.

Examples of water-based coating compositions include cathodic or anodic electrodeposition paints, for example, for automobile bodies. Other examples include plasters, silicate paints, emulsion paints, water-based paints based on water dilutable alkyds, alkyd emulsions, hybrid systems, two-component systems, polyurethane and acrylate dispersions. Both one-component systems and two-component systems are possible, wherein in the latter case, in general, also polyisocyanates, melamine resins and/or polyamide resins are present in the second component as the typical crosslinking agents known to the person skilled in the art.

Water-based is to be understood that the coating composition contains mainly water as a solvent. A water-based coating composition in particular will contain not more than 20% by weight organic solvent, based on the total amount of solvent present in the coating composition.

The coating composition may comprise further ingredients, for example, photo-initiators, defoamers, wetting agents, film-forming additives, such as cellulose derivatives (for example, cellulose nitrates, cellulose acetates, cellulose acetobutyrate), reactive diluents, flow control agents, dispersants and/or rheology controlling additives.

The pigment concentrates and coating composition preferred as products according to the invention are produced by methods known to the person skilled in the art, such as, for example, stepwise addition, while stirring and mixing the components of the coating composition in conventional mixing equipment, such as stirred vessels or dissolvers.

### EXAMPLES

### Abbreviations

4VP 4-Vinylpyridine
ACVA 4,4′-Azobis(4-cyanovaleric acid)
CVDT 4-Cyano-4-(((dodecylthio) carbonothioyl)thio) valeric acid
Ð Polydispersity M_{w}/Mₙ
DMAE Dimethylaminoethanol
HEMA (Hydroxyethyl) methacrylate
M_{C} Hue-dependent blackness value
MMA Methyl methacrylate
Mₙ Number average molecular weight (by GPC)
PEGMA (xyz) Poly(ethylene oxide) methyl ether methacrylate with number average molecular weight xyz g/mol
PM Propylene glycol mono methyl ether

### ACVA Stock Solution

1 g ACVA (3.6 mmol), 640 mg DMAE (7.1 mmol) and 98.36 g water were mixed and stirred until the raw materials were completely dissolved.

### Example 1

A monomer composition of PEGMA 550 and water (1:1 vol) was prepared and degassed for 1 h by purging with nitrogen. For the polymerization of the first block, 1.35 g 4-cyano-4-(((dodecylthio) carbonothioyl)thio)pentanoic acid (3.34 mmol), 46.9 mg ACVA (167 μmol), 262 mg DMAE (2.94 mmol), 530 mg BYK-011 (defoamer), 34.1 mL water and 21.2 g (containing 11.1 g PEGMA 550 and 10.1 g water) monomer composition were added into a 250 mL four-neck round bottom flask, which was equipped with a CPG stirrer, an inner thermometer, bubble counter and a septum. The batch was degassed by purging with nitrogen for 1 h and heated up to 70° C. When the temperature was reached, 49.6 g (containing 25.9 g PEGMA 550 and 23.7 g water) monomer composition were pumped into the flask within 1.5 min using a syringe pump. The reaction solution was further stirred for 2.5 h and cooled subsequently (Mₙ: 12.1 kg/mol, Ð: 1.28).

For the polymerization of the second block, 2.38 mL 4-Vinylpyridine (2.35 g, 22.4 mmol), 2.58 mL Styrene (2.33 g, 22.4 mmol) and 6.32 mL ACVA stock solution (10 g/L) were added into the flask. The batch was degassed by purging with nitrogen for 1 h before the reaction. The reaction was performed at 65° C. for 1 h, 70° C. for 1 h and 80° C. for 2 h (Mₙ: 16.2 kg/mol, Ð: 1.36).

### Example 2

A monomer composition of PEGMA 550 and water (1:1 vol) was prepared and degassed for 1 h by purging with nitrogen. For the polymerization of the first block, 1.35 g 4-cyano-4-(((dodecylthio) carbonothioyl)thio)pentanoic acid (3.34 mmol), 46.9 mg ACVA (167 μmol), 262 mg DMAE (2.94 mmol), 530 mg BYK-011 (defoamer), 34.1 mL water and 21.2 g monomer composition (containing 11.1 g PEGMA 550 and 10.1 g water) were added into a 250 mL four-neck round bottom flask, which was equipped with a CPG stirrer, an inner thermometer, bubble counter and a septum. The batch was degassed by purging with nitrogen for 1 h and heated up to 70° C. When the temperature was reached, 49.6 g (containing 25.9 g PEGMA 550 and 23.7 g water) monomer composition were pumped into the flask within 1.5 min using a syringe pump. The reaction solution was further stirred for 2.5 h and cooled subsequently (Mₙ: 12.1 kg/mol, Ð: 1.28).

For the polymerization of the second block, 7.27 mL 2-Vinylpyridine (7.05 g, 67.0 mmol) and 6.32 mL ACVA stock solution (10 g/L) were added into the flask. The batch was degassed by purging with nitrogen for 1 h before the reaction. The reaction was performed at 65° C. for 1 h, 70° C. for 1 h and 80° C. for 2 h (Conversion: 98%, Mₙ: 16.2 kg/mol, Mₚ: 17.6 kg/mol, Ð: 1.36).

### Example 3

A monomer composition of PEGMA 550 and water (1:1 vol) was prepared and degassed for 1 h by purging with nitrogen. For the polymerization of the first block, 1.35 g 4-cyano-4-(((dodecylthio) carbonothioyl)thio)pentanoic acid (3.34 mmol), 46.9 mg ACVA (167 μmol), 262 mg DMAE (2.94 mmol), 530 mg BYK-011 (defoamer), 34.1 mL water and 21.2 g (containing 11.1 g PEGMA 550 and 10.1 g water) monomer composition were added into a 250 mL four-neck round bottom flask, which was equipped with a CPG stirrer, an inner thermometer, bubble counter and a septum. The batch was degassed by purging with nitrogen for 1 h and heated up to 70° C. When the temperature was reached, 49.6 g (containing 25.9 g PEGMA 550 and 23.7 g water) monomer composition were pumped into the flask within 1.5 min using a syringe pump. The reaction solution was further stirred for 2.5 h and cooled subsequently (Mₙ: 12.1 kg/mol, Ð: 1.28).

For the polymerization of the second block, 3.85 mL Styrene (3.50 g, 33.6 mmol) and 6.32 mL ACVA stock solution (10 g/L) were added into the flask. The batch was degassed by purging with nitrogen for 1 h before the reaction. The reaction was performed at 65° C. for 1 h, 70° C. for 1 h and 80° C. for 2 h.

### Example 4

0.8 g 4-cyano-4-(((dodecylthio) carbonothioyl)thio)pentanoic acid (1.98 mmol), 32.7 g (59.5 mmol) PEGMA 550, 0.23 g (2.6 mmol) DMAE, 3.1 g ACVA stock solution, 51 g water and 450 mg BYK-011 (defoamer) were added to a flask, stirred, and degassed for 1 h by purging with nitrogen. After 1 h the mixture was heated up to 70° C. After 1 h at 70° C., 0.66 g (6.6 mmol) MMA and 0.5 g ACVA stock solution were added 3 times within 1.5 hours at an interval of 30 minutes. After adding MMA the reaction was performed at 70° C. for 3 h.

For the polymerization of the second block, 4.17 g (39.6 mmol) 4-VP and 5.55 g ACVA stock solution were added to the flask. The batch was degassed by purging with nitrogen for 1 h before the reaction. The reaction was performed at 65° C. for 1 h, at 70° C. for 1 h and at 80° C. for 3 h.

### Example 5

0.82 g 4-cyano-4-(((dodecylthio) carbonothioyl)thio)pentanoic acid (2.03 mmol), 22.34 g (0.04 mol) PEGMA 550, 11.58 g (0.012 mol) PEGMA 950, 0.24 g (2.64 mmol) DMAE, 2.85 g ACVA stock solution, 51.42 g water and 450 mg BYK-011 (defoamer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 4.27 g (41 mmol) 4-VP and 5.69 g ACVA stock solution were added to the flask. The batch was degassed by purging with nitrogen for 1 h before the reaction. The reaction was performed at 65° C. for 1 h, 70° C. for 1 h and 80° C. for 3 h.

### Example 6

0.76 g 4-Cyano-4-(((dodecylthio) carbonothioyl)thio)pentanoic acid (1.88 mmol), 31.06 g (56.5 mmol) PEGMA 550, 0.22 g (2.45 mmol) DMAE, 2.64 g ACVA stock solution, 50.3 g water and 450 mg BYK-011 (defoamer) were added to a flask, stirred, and degassed for 1 h by purging with nitrogen. After 1 h the mixture was heated up to 70° C. After 1 h at 70° C., 1.26 g (12.6 mmol) MMA and 0.5 g ACVA stock solution were added 3 times within 1.5 h at an interval of 30 minutes. After adding MMA the reaction was continued at 70° C. for 3 h.

For the polymerization of the second block, 3.96 g (37.7 mmol) 4-VP and 5.28 g ACVA stock solution were added to the flask. The batch was degassed by purging with nitrogen for 1 h before the reaction. The reaction was performed at 65° C. for 1 h, at 70° C. for 1 h and at 80° C. for 3 h.

### Example 7

1.22 g 4-Cyano-4-(((dodecylthio) carbonothioyl)thio)pentanoic acid (3.0 mmol), 21.15 g (60.4 mmol) PEGMA 350, 10.58 g (30.2 mmol) polypropylene glycol mono methacrylate, Mₙ 350 g/mol, 0.5 g (5.6 mmol) DMAE, 6.2 g ACVA stock solution, 44.7 g water and 450 mg BYK-011 (defoamer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 6.35 g (60 mmol) 4-VP and 8.47 g ACVA stock solution were added to the flask. The batch was degassed by purging with nitrogen for 1 h before the reaction. The reaction was performed at 65° C. for 1 h, 70° C. for 1 h and 80° C. for 3 h.

### Example 8

0.9 g 4-Cyano-4-(((dodecylthio) carbonothioyl)thio)pentanoic acid (2.22 mmol), 36 g (37.9 mmol) PEGMA 950, 0.26 g (2.9 mmol) DMAE, 3.1 g ACVA stock solution, 48.5 g water and 450 mg BYK-011 (defoamer) were added to a flask, stirred, and degassed for 1 h by purging with nitrogen. After 1 h the mixture heated up to 70° C. When the temperature was reached, the reaction was performed at 70° C. for 5 h.

For the polymerization of the second block, 4.69 g (45 mmol) 4-VP and 6.25 g ACVA stock solution were added to the flask. The batch was degassed by purging with nitrogen for 1 h before the reaction. The reaction was performed at 65° C. for 1 h, 70° C. for 1 h and 80° C. for 3 h.

### Example 9

0.91 g 2-(((Dodecylthio) carbonothioyl)thio)propanoic acid (2.6 mmol), 30.98 g (64.5 mmol) methoxy polyethylene monoacrylate of Mₙ 400 g/mol, 3.62 g (12.9 mmol) butyl acrylate, 0.26 g (2.9 mmol) DMAE, 3.31 g ACVA stock solution, 47.47 g water and 450 mg BYK-011 (defoamer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 5.43 g (52 mmol) 4-VP and 7.24 g ACVA stock solution were added to the flask. The batch was degassed by purging with nitrogen for 1 h before the reaction. The reaction was performed at 65° C. for 1 h, 70° C. for 1 h and 80° C. for 3 h.

### Example 10

A monomer composition of PEGMA 550 and water (1:1 vol) was prepared and degassed for 1 h by purging with nitrogen. For the polymerization of the first block, 1.35 g 4-cyano-4-(((dodecylthio) carbonothioyl)thio)pentanoic acid (3.34 mmol), 46.9 mg ACVA (167 μmol), 262 mg DMAE (2.94 mmol), 530 mg BYK-011 (defoamer), 34.1 mL water and 21.3 g monomer composition were added into a 250 mL four-neck round bottom flask, which was equipped with a CPG stirrer, an inner thermometer, bubble counter and a septum. The batch was degassed by purging with nitrogen for 1 h and heated up to 70° C. When the temperature was reached, 49.6 g monomer composition were pumped into the flask within 1.5 min using a syringe pump. The reaction solution was further stirred for 2.5 h and cooled subsequently (Mₙ: 12.1 kg/mol, Ð: 1.28).

For the polymerization of the second block, 3.55 mL 4VP (3.52 g, 33.4 mmol) and 9.36 mL ACVA stock solution (10 g/L) were added into the flask. The batch was degassed by purging with nitrogen for 1 h before the reaction. The reaction was performed at 65° C. for 1 h, 70° C. for 1 h and 80° C. for 2 h (Mₙ: 13.1 kg/mol, Ð: 1.32).

### Example 11

A monomer composition was created by a mixture of PEGMA 550 and HEMA (molar ratio 2:1) and was diluted with water (50 vol % water). 1.20 g 4-Cyano-4-(((dodecylthio) carbonothioyl)thio)pentanoic acid (2.97 mmol), 41.7 mg ACVA (149 μmol), 233 mg DMAE (2.62 mmol), 529 mg BYK-011 (defoamer) and 33.9 mL water were added to the flask (molar ratio CVDT/ACVA/monomer 1:0.05:30). 21.1 g monomer composition were added to the flask, 49.3 g were added during the first 90 min using a syringe pump (Mₙ: 14.4 kg/mol, Ð: 1.42). The reaction was carried out for 1.5 h at 65° C. and 2.5 h at 70° C.

For the second polymer block, 6.32 mL 4VP (6.25 g, 59.4 mmol) and 8.32 mL of an ACVA stock solution (10 g/L) were added to the flask and the reaction was carried out at 65° C. for 1 h, 70° C. for 1 h and 80° C. for 2 h. (Mₙ: 16.4 kg/mol, Ð: 1.48).

### Example 12

0.3 g 2,2′-[Carbonothioylbis(thio)]bis[2-methylpropanoic acid] (1.05 mmol), 34.71 g (63 mmol) PEGMA 550, 0.26 g (2.9 mmol) DMAE, 4.42 g ACVA stock solution, 46.7 g water and 450 mg BYK-011 (defoamer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 4.42 g (42 mmol) 4-VP and 8.84 g ACVA stock solution were added to the flask. The batch was degassed by purging with nitrogen for 1 h before the reaction. The reaction was performed at 65° C. for 1 h, 70° C. for 1 h and 80° C. for 3 h.

### Example 13

For the polymerization of the first block 900 mg 4-cyano-4-(((dodecylthio) carbonothioyl)-thio)pentanoic acid (2.23 mmol), 31.2 mg ACVA (111 μmol), 36.8 g PEGMA 550 (66.9 mmol), 175 mg DMAE (1.96 mmol), 106 mg BYK-011 (defoamer), 51.1 g water and 17.0 g propylene glycol methyl ether (PM) were given into a 250 mL four-neck round bottom flask, which was equipped with a stirrer, an inner thermometer, bubble counter and a septum. The reaction solution was degassed by purging with nitrogen for 1 h. The reaction was carried out for 1.5 h at 65° C. and 2.5 at 70° C. (Mₙ: 15.4 kg/mol, Ð: 1.27).

For the second polymer block, 4.75 mL 4VP (4.69 g, 44.6 mmol) and 6.25 mL of an ACVA stock solution (10 g/L) and 1.52 g PM were added into the flask. After degassing for 1 h, the reaction was carried out at 65° C. for 1 h, 70° C. for 1 h and 80° C. for 2 h (Mₙ: 17.3 kg/mol, Ð: 1.31).

### Example 14

The aqueous product of Example 10 was heated to 80° C. and the water was distilled off under reduced pressure. The obtained product was highly viscous and amber in color.

### Example 15

0.84 g 4-Cyano-4-(((dodecylthio) carbonothioyl)thio)pentanoic acid (2.08 mmol), 34.33 g (62.4 mmol) PEGMA 550, 0.24 g (2.7 mmol) DMAE, 0.054 g 2,2′-azobis[2-(2imidazolin-2-yl) propane]dihydrochloride, 59 g water and 450 mg BYK-011 (defoamer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 4.38 g (42 mmol) 4-VP and 0.07 g 2,2′-azobis[2-(2imidazolin-2-yl) propane]dihydrochloride were added to the flask. The batch was degassed by purging with nitrogen for 1 h before the reaction. The reaction was performed at 65° C. for 1 h, 70° C. for 1 h and 80° C. for 3 h.

### Example 16

0.66 g (1.64 mmol), 4-cyano-4-(((dodecylthio) carbonothioyl)thio)pentanoic acid 14.7 g (26.7 mmol) PEGMA 550, 0.19 g (2.1 mmol) DMAE, 2 g ACVA stock solution, 55 g water and 470 mg BYK-011 (defoamer) were added to a flask, stirred, and degassed for 1 h by purging with nitrogen. After 1 h the mixture was heated up to 70° C. After 1 h at 70° C. a mixture of 7.3 g (13.3 mmol) PEGMA 550 and 10.46 g (73.6 mmol) butyl methacrylate was dosed over 90 min. Simultaneously, 2 g ACVA stock solution was dosed over 90 min. After dosing the monomers, the reaction was performed at 70° C. for 3 h.

For the polymerization of the second block, 5.16 g (49 mmol) 4-VP and 5.16 g ACVA stock solution were added to the flask. The batch was degassed by purging with nitrogen for 1 h before the reaction. The reaction was performed at 65° C. for 1 h, at 70° C. for 1 h and at 80° C. for 3 h.

### Example 17

For the polymerization of the first block 0.85 g 4-cyano-4-(((dodecylthio) carbonothioyl)-thio)pentanoic acid (2.1 mmol), 34.74 g (63.2 mmol) PEGMA 350, 0.24 g (2.75 mmol) DMAE, 2.95 g ACVA stock solution, 50 g Water and 450 mg BYK-011 (defoamer) were added to a flask, stirred, and degassed for 1 h by purging with nitrogen. After 1 h the mixture was heated to 70° C. When the temperature was reached, the reaction was performed at 70° C. for 5 h.

For the polymerization of the second block, 3.32 g (31.6 mmol) 4-VP and 5.9 g ACVA stock solution were added to the flask. The approach was degassed with nitrogen for 1 h before the reaction. The reaction was performed at 65° C. for 1 h, 70° C. for 1 h and 80° C. for 3-4 h.

For the polymerization of the third block, 1.09 g (10.5 mmol) Styrene and 2.5 g ACVA stock solution were dosed over 90 min. The approach was further degassed with nitrogen during the reaction. 1 h after dosing the reaction was post-initiated with 1 g ACVA stock solution. The reaction was performed at 80° C. for 2 h. Mₙ: 16.0 kg/mol, Ð: 1.28)

By introduction of the third block, residual 4-vinylpyridine monomer dropped from 600 ppm to 30 ppm.

### Example 18

A monomer composition of PEGMA 550 and water (1:1 vol) was prepared and degassed for 1 h by purging with nitrogen. For the polymerization of the first block, 1.8 g 4-cyano-4-(((dodecylthio) carbonothioyl)thio)pentanoic acid (4.45 mmol), 62.4 mg ACVA (222 μmol), 520 mg DMAE (5.8 mmol), 900 mg BYK-011 (defoamer), 18 mL water and 21.3 g monomer composition were added into a 250 mL four-neck round bottom flask, which was equipped with a stirrer, an inner thermometer, bubble counter and a septum. The batch was degassed by purging with nitrogen for 1 h and heated up to 70° C. When the temperature was reached, 49.6 g monomer composition were pumped into the flask within 1.5 min using a syringe pump. The reaction solution was further stirred for 2.5 h and cooled subsequently (Mₙ: 12.1 kg/mol, Ð: 1.28).

For the polymerization of the second block, 3.55 mL 4VP (3.52 g, 33.4 mmol) and 9.36 mL ACVA stock solution (10 g/L) were added into the flask. The batch was degassed by purging with nitrogen for 1 h before the reaction. The reaction was performed at 65° C. for 1 h, 70° C. for 1 h and 80° C. for 2 h (Mₙ: 13.1 kg/mol, Ð: 1.32).

### Example 19

For the polymerization of the first block 0.83 g 4-cyano-4-(((dodecylthio) carbonothioyl)thio)-pentanoic acid (2.06 mmol), 33.92 g (61.7 mmol) PEGMA 550, 0.24 g (2.7 mmol) DMAE, 2.88 g ACVA stock solution, 43 g water and 450 mg BYK-011 (deformer) were added to a flask, stirred, and degassed for 1 h by purging with nitrogen. After 1 h the mixture was heated up to 70° C. When the temperature was reached, the reaction was performed at 70° C. for 5 h.

For the polymerization of the second block, 3.24 g (30.8 mmol) 4-VP and 7.01 g ACVA stock solution were added to the flask. The batch was degassed with nitrogen for 1 h before the reaction. The reaction was performed at 65° C. for 1 h, 70° C. for 1 h and 80° C. for 3-4 h.

For the polymerization of the third block, 1.81 g (10.3 mmol) benzyl methacrylate and 7.01 g ACVA stock solution were added. The reaction was performed at 80° C. for 2 h. Mₙ: 15.7 kg/mol, Ð: 1.43).

By introduction of the third block, residual 4-vinylpyridine monomer dropped from 500 ppm to 35 ppm.

### Comparative Example 1

Comparative Example 1 is a copolymer of butyl acrylate and 4-vinylpyridine which was transesterified with methoxy poly ethylene glycol, according to example A3 of U.S. Pat. No. 8,658,741 B.

### Application Testing

Pigment stabilization with Raven 5000 Ultra III Powder in an aqueous coating composition

Grinding type was an aqueous binder-free pigment paste.

The pigment Raven 5000 Ultra III Powder is a Black 7 pigment from the company BIRLA CARBON.

The aqueous binder system is a combination of the acrylic co-polymers Setaqua 6801 and 6802 from ALLNEX.

Formulation base clearcoat for OEM coatings

| | |
|---|---|
| Setaqua 6801 AQ-24 | 238.0 |
| Setaqua 6802 AQ-24 | 449.0 |
| BYK-028 | 6.0 |
| BYK-348 | 5.0 |
| Butyl glycol | 57.0 |
| Deionized water | 238.6 |
| Dimethyl ethanol amine (DMEA) 50% | 6.4 |
| aqueous solution | |
| | 1000.0 |

The first 4 components were placed in a beaker and mixed, followed by the next three components and further mixing.

Pigment pastes were produced with an additive dosage of 70% active substance on pigment.

Formulation Pigment Paste Black

Pigment Black 7

| | 35% | 40% | 50% | 52% | 60% | 100% |
|---|---|---|---|---|---|---|
| Water | 30.25 | 31.85 | 34.15 | 34.50 | 35.65 | 38.70 |
| Additive | 13.00 | 11.40 | 9.10 | 8.75 | 7.60 | 4.55 |
| BYK-024 | 0.25 | 0.25 | 0.25 | 0.25 | 0.25 | 0.25 |
| Pigment | 6.50 | 6.50 | 6.50 | 6.50 | 6.50 | 6.50 |
| | 50.00 | 50.00 | 50.00 | 50.00 | 50.00 | 50.00 |

The dispersion container was a 100 mL wide-necked glass with screw cap. All components were weighed in and completed with 1 mm glass beads in a 1:1 weight ratio.

The closed glasses were clamped and shaken in the LAU disperser for 180 min at level 3 dispersion cooling.

The finished pigment pastes were then separated from the glass beads by sieving into a 175 ml beaker using a 210 μm filter.

The viscosity of the pigment paste was determined by stirring with a spatula.

The pigment paste was adjusted to pH 8 to 9 with DMEA 50%.

Mixtures with a pigment content of 1.5% by weight were prepared and shaken for 2 min.

Mixing formulation

| Mixture | 1.5% Pigment |
|---|---|
| Pigment paste | 2.00 |
| Base clear coat | 15.00 |
| Total | 17.00 |

The mixtures rested overnight and were then applied to PE film using a film applicator and a 120 μm spiral squeegee.

Drying took place after 15 min flash-off time for 15 min at 80° C. in a convection oven.

A clearcoat was applied on the black basecoat, dried for 5 minutes at room temperature and for 20 min at 120° C. in a convection oven.

The jetness of the coating system was measured with a BYK-Gardner spectro-guide gloss-45/0 for MC, MY and dM values. These values should be as high as possible.

| | MC | MY | dM |
|---|---|---|---|
| Comparative Example 1 | 312 | 305 | 7 |
| Example 1 | 315 | 305 | 10 |
| Example 2 | 317 | 305 | 12 |
| Example 4 | 317 | 305 | 12 |
| Example 5 | 322 | 310 | 12 |
| Example 8 | 315 | 305 | 10 |
| Example 10 | 322 | 310 | 12 |

### Application Examples Inkjet

To evaluate the effectiveness of the inventive polymer as pigment dispersant, it was tested in different inkjet millbases.

### Application Example 1: Aqueous Dispersion

As first step, aqueous pigment dispersions with two different pigments were made with a Pigment Red 150 (Fuji Fast Carmine 522-1D) and a Pigment Blue 15:3 (PV Fast Blue BG). The components shown in Table 1 were combined in a 100 mL glass bottle and afterwards dispersed in a Lau-Disperser with 100 g Zirconia beads (0.5 mm) to create the pigment concentrates (16 h shaking with cooling level 3).

TABLE 1
Composition of the pigment concentrates.

| | Pigment | Pigment |
|---|---|---|
| | Concentrate | Concentrate |
| Raw material | PR150 | PB15:3 |
| Water | 31.70 | 31.70 |
| Inventive or | 8.00 | 8.00 |
| comparative polymers | | |
| BYK-019 | 0.30 | 0.30 |
| Fuji Fast Carmine 522- | 10.00 | |
| 1D (PR150) | | |
| PV Fast Blue BG | | 10.00 |
| (PB15:3) | | |
| | 50.00 | 50.00 |

BYK-019 is a silicone defoamer from BYK-Chemie GmbH, Fuji Fast Carmine 522-1D is an organic red pigment with Color Index Pigment Red 150 from Fuji Pigment Co.Ltd, PV Fast Blue BG is a phthalocyanine pigment with Color Index Pigment Blue 15:3 from Clariant.

The particle sizes of the pigment concentrates were measured directly after grinding and after storage (2 weeks at 60° C.). The particle size values of the pigment concentrates using the polymer of Example 10 (present invention) and comparative example 1 are shown in Table 2 and 3 below. The particle size was measured via dynamic light scattering (NanoPlus DLS).

TABLE 2
Particle size values of samples of pigment concentrate
Fuji Fast Carmine 522-1D (PR150)

| | Particle Size | Particle Size |
|---|---|---|
| | (D50 in nm) | (D50 in nm) |
| | after grinding | after storage |
| Polymer sample | Pigment | Pigment |
| | Concentrate | Concentrate |
| | PR150 | PR150 |
| Comp. Example 1 | 215 | 213 |
| Example 10 | 179 | 181 |

The inventive sample shows a better particle size reduction than the comparative example.

TABLE 3
Particle size values of samples of pigment
concentrates PV Fast Blue BG (PB15:3)

| | Particle Size | Particle Size |
|---|---|---|
| | (D50 in nm) | (D50 in nm) |
| | after grinding | after storage |
| Polymer sample | Pigment | Pigment |
| | Concentrate | Concentrate |
| | PB15:3 | PB15:3 |
| Comp. Example 1 | 185 | 634 |
| Example 10 | 178 | 185 |

The particle size and stability for PB15:3 also improved with the inventive product.

### Application Example 2: Eco-Solvent Dispersion

As second step, solvent-based pigment dispersions with an organic pigment were made with a Pigment Red 146 (Permanent Carmine FBB02) in diethylene glycol diethyl ether (DEGDEE). The components shown in Table 4 were combined in a 100 mL glass bottle and afterwards dispersed in a Lau-Disperser with 100 g Zirconia beads (0.5 mm) to create the pigment concentrates (16 h shaking with cooling level 3).

TABLE 4
Composition of the pigment concentrates.

| | Pigment Concentrate |
|---|---|
| Raw material | PR146 |
| DEGDEE | 38.75 |
| Inventive or | 3.75 |
| comparative polymers | |
| Permanent Carmine | 7.50 |
| FBB02 (PR146) | |
| | 50.00 |

DEGDEE is diethylene glycol diethyl ether, Permanent Carmine FBB02 is an organic red pigment with Color Index Pigment Red 146 from Clariant.

The viscosities and particle sizes of the pigment concentrates were measured directly after grinding and after storage (2 weeks at 60° C.). The viscosity and particle size values of the pigment concentrates using the polymer of Example 14 (present invention) and comparative example 1 are shown in Table 5 below. The viscosity was measured with an Anton Paar rheometer (25 mm Ø, 1°, 25° C.) at a shear rate of 100 s⁻¹. The particle size was measured via dynamic light scattering (NanoPlus DLS)

TABLE 5
Viscosity and particle size values of samples of pigment
concentrate Permanent Carmine FBB02 (PR146)

| | mPa s at 100 s⁻¹ | mPa s at 100 s⁻¹ |
|---|---|---|
| | after grinding | after storage |
| Polymer sample | Pigment | Pigment |
| | Concentrate | Concentrate |
| | PR146 | PR146 |
| Comp. Example 1 | 9.1 | 8.3 |
| Example 14 | 8.3 | 7.3 |

The inventive sample shows a better viscosity reduction than the comparative example.

### Application Example 3: UV Curing Dispersion

As third step, UV-based pigment dispersions with organic pigments were made with a Pigment Yellow 155 (Inkjet Yellow 4GC), a Pigment Red 122 (Fastogen Super Magenta RG) and a Pigment Blue 15:4 (Heliogen Blue D7110F) in a 1:1 mixture of PONPGDA/DPGDA. The components shown in Table 6 were combined in a 100 mL glass bottle and afterwards dispersed in a Lau-Disperser with 100 g Zirconia beads (0.5 mm) to create the pigment concentrates (16 h shaking with cooling level 3).

TABLE 6
Composition of the pigment concentrates.

| | Pigment | Pigment | Pigment |
|---|---|---|---|
| | Concentrate | Concentrate | Concentrate |
| Raw material | PY155 | PR122 | PB15:4 |
| PONPGDA/DPGDA 1:1 | 38.75 | 38.75 | 36.00 |
| Inventive or comparative | 3.75 | 3.75 | 4.00 |
| polymers | | | |
| Inkjet Yellow 4GC | 7.50 | | |
| (PY155) | | | |
| Fastogen Super Magenta | | 7.50 | |
| RG (PR122) | | | |
| Heliogen Blue D7110F | | | 10.00 |
| (PB15:4) | | | |
| | 50.00 | 50.00 | 50.00 |

PONPGDA is propoxylated 2-neopentyl glycol diacrylate, DPGDA is dipropylene glycol diacrylate, Inkjet Yellow 4GC is an organic yellow pigment with Color Index Pigment Yellow 155 from Heubach (former Clariant), Fastogen Super Magenta RG is an organic magenta pigment with Color Index Pigment Red 122 from DIC and Heliogen Blue D7110F is an organic cyan pigment with Color Index Pigment Blue 15:4 from DIC (former BASF).

The viscosities and particle sizes of the pigment concentrates were measured directly after grinding. The viscosity and particle size values of the pigment concentrates using the polymers according to the invention and comparative example 1 are shown in Table 7, 8 and 9 below. The viscosity was measured with an Anton Paar rheometer (2 5 mm Ø, 1°, 25° C.) at a shear rate of 100 s⁻¹. The Particle size was measured via Dynamic Light Scattering (NanoPlus DLS)

TABLE 7
Viscosity and particle size values of samples of
pigment concentrate Inkjet Yellow 4GC (PY155)

| | | Particle Size |
|---|---|---|
| | mPa s at 100 s⁻¹ | (D50 in nm) |
| Polymer sample | Pigment | Pigment |
| | Concentrate | Concentrate |
| | PY155 | PY155 |
| Comp. Example 1 | 62.0 | 169 |
| Example 10 | 49.0 | 162 |

The inventive sample shows a better viscosity reduction than the comparative example.

TABLE 8
Viscosity and particle size values of samples of pigment
concentrate Fastogen Super Magenta RG (PR122)

| | | Particle Size |
|---|---|---|
| | mPa s at 100 s⁻¹ | (D50 in nm) |
| Polymer sample | Pigment | Pigment |
| | Concentrate | Concentrate |
| | PR122 | PR122 |
| Comp. Example 1 | 73.8 | 180 |
| Example 18 | 41.9 | 157 |

The inventive sample shows a better viscosity and particle size reduction than the comparative example.

TABLE 9
Viscosity and particle size values of samples of
pigment concentrate Heliogen Blue D7110F (PB15:4)

| | | Particle Size |
|---|---|---|
| | mPa s at 100 s⁻¹ | (D50 in nm) |
| Polymer sample | Pigment | Pigment |
| | Concentrate | Concentrate |
| | PB 15:4 | PB 15:4 |
| Comp. Example 1 | 86.0 | 130 |
| Example 10 | 65.9 | 125 |

The inventive sample shows a better viscosity and particle size reduction than the comparative example.

1. A process for preparing a block copolymer comprising polymerizing in an aqueous medium under reversible-addition-fragmentation chain-transfer polymerization conditions
a) a first monomer composition comprising methacrylic acid in an amount of 0.0 to 40.0 mol-%, and at least 50.0 mol-% of one or more ethylenically unsaturated polymerizable monomers having a water solubility of more than 500 g/l at 20° C., selected from monomers having ether groups and monomers having hydroxyl groups, to prepare a first polymer block, and
b) a second monomer composition comprising at least 60.0% by weight of one or more ethylenically unsaturated polymerizable monomers having a water solubility of less than 50 g/l at 20° C. to prepare a second polymer block.

2. The process according to claim 1, wherein the first monomer composition comprises methacrylic acid in an amount of 0.0 to 25.0 mol-%.

3. The process according to claim 1, wherein the block copolymer has a number average molecular weight in the range of 5000 to 30000 g/mol.

4. The process according to claim 1, wherein the second monomer composition comprises at least one of 4-vinylpyridine, 2-vinylpyridine, and styrene.

5. The process according to claim 1, comprising a further step, wherein a third monomer composition is added after preparation of the second block to prepare a third block.

6. The process according to claim 1, wherein the process is carried out in the presence of a defoaming agent.

7. The process according to claim 1, wherein first monomer composition comprises at least 60.0% by weight of one or more ethylenically unsaturated polymerizable monomers having a water solubility of more than 500 g/l at 20° C.

8. The process according to claim 1, wherein the process is carried out in the presence of
i) a radical generating agent having a water solubility of more than 10 g/l at a temperature of 20° C. and
ii) a chain transfer agent having a thiocarbonyl-thio group of the formula (I) —C(═S)—S—.

9. A block copolymer comprising
a) a first block comprising polymerized units of one or more ethylenically unsaturated polymerizable monomers, wherein the first block comprises polymerized units of methacrylic acid in an amount of 0.0 to 40.0 mol-%, and at least 50.0 mol-% of polymerized units of one or more ethylenically unsaturated polymerizable monomers having a water solubility of more than 500 g/l at 20° C., selected from monomers having ether groups and monomers having hydroxyl groups, and
b) a second block comprising polymerized units of one or more ethylenically unsaturated polymerizable monomers, wherein the second block comprises at least 60.0% by weight of polymerized units of one or more ethylenically unsaturated polymerizable monomers having a water solubility of less than 50 g/l at 20° C.

10. The block copolymer according to claim 9, wherein the weight ratio of the first block to the second block is in the range of 50:50 to 95:5.

11. The block copolymer according to claim 10, wherein the block copolymer comprises a third block.

12. An aqueous composition comprising water and a block copolymer according to claim 9.

13. (canceled)

14. (canceled)

15. A process of dispersing solid particles in a dispersion medium, comprising
providing a block copolymer according to claim 9,
providing solid particles,
providing an aqueous dispersion medium or using an aqueous medium according to claim 9 as dispersion medium,
mixing the block copolymer, solid particles and an aqueous dispersion medium or aqueous medium according to claim 9 in any suitable order and exerting shear force.

16. A coating composition comprising
a) solid particles,
b) a block copolymer according to claim 9, and
c) a film-forming binder.

17. The coating composition according to claim 16, wherein the composition is an aqueous composition comprising a continuous aqueous phase.

18. The process according to claim 15, wherein the solid particles comprise at least one of pigment particles and filler particles.
